(19) United States
(12) Patent Application Publication
(10) Pub. No.: US 2002/0029707 A1
(43) Pub. Date: Mar. 14, 2002

(54) Apparatus for cleaning alternatively two or more cylinders of a printing machine by means of a single cleaning device

(76) Inventors: Marco Corti, Lecco (IT); Riccardo Fumagalli, Oggiono (IT)

Correspondence Address: LARSON & TAYLOR, PLC, 1199 NORTH FAIRFAX STREET, SUITE 900, ALEXANDRIA, VA, 22314, US

(21) Appl. No.: 09/946,529

(22) Filed: Sep. 6, 2001

(30) Foreign Application Priority Data
Sep. 8, 2000 (IT) BO2000 A 000521

(51) Int. Cl. B41F 1/00; B41F 35/00

(52) U.S. Cl. 101/425

(57) ABSTRACT

The cleaning device (B, P, T, R1, R2) is attached at each end to shoulders (S) pivoting on a pair of parallel arms (2) connected, to each other by a robust cross member (5), these arms being hinged at the other end to the side walls (F) of the machine. At this hinge end, there pivots on at least one of the arms (2) an assembly of pneumatic actuators (11, 12), which actuators pivot at the other end on a lug (9) integral with one of the shoulders (S) of the cleaning device, which shoulders are provided, on the opposite side from the said lug, with spindles or rollers (6) that run in cam paths (7) formed in plates (8) attached to the said side walls of the printing machine. By means of the assembly of pneumatic actuators (11, 12) and of the said linear cams (7), the cleaning device can be oriented and positioned at will against either of the two cylinders to be cleaned (C1, C2) or can be set in a position remote from both of these cylinders, this position being useful as a rest position and a position for maintenance of the apparatus. Mounted on at least one of the said arms (7) or on both of the shoulders (S) of the cleaning device are idle rollers (16) designed to engage with corresponding cams (D) fitted to the ends of the plate cylinder (C2), across the gap or gaps (G) containing the clamps (E) that hold the plate on this cylinder, so that the cleaning device is moved away automatically whenever it passes over the clamps, thus preventing any interference with these.

### DESCRIPTION

The invention relates to an apparatus for cleaning alternatively and at will two or more neighbouring cylinders in a printing machine, by means of a single cleaning device.

Examples of such equipment are described in US patents U.S. Pat. No. 5,408,930 (Loos) and U.S. Pat. No. 5,479,857 (Braun) where the cleaning apparatus can rotate about an axis parallel to the presser which can thus be oriented alternatively against either of two parallel neighbouring cylinders inside the printing machine. Once the presser is correctly oriented relative to a cylinder, it is deformed elastically and/or pushed towards that cylinder so as to touch it with the cloth, which is soaked with the cleansing fluids. These devices are not designed to also operate on cylinders in which there are gaps on the surface, containing for example clamps, as for instance in plate cylinders, in which the cleaning cloth could interfere with the said clamps and be torn. Also known is the device disclosed in PCT patent application WO 00/34045 in the name of the present applicants, where the cleaning device is supported by means which on command enable it to perform a rotary or pivoting movement about an axis, possibly represented by an actual shaft, that is parallel to and located between the two cylinders to be cleaned, while other means cause the same cleaning device to perform a simultaneous rotary or pivoting movement about their own longitudinal axis which passes through the points of attachment to the said supporting means. This device, unlike the US patent devices mentioned above, includes a component of displacement perpendicular to the cylinder that is to be cleaned, and this component is made use of to ensure that the device can automatically avoid interference between the cleaning cloth and the clamps of a plate cylinder. To this end the cleaning device is provided on at least one end with an idle roller able to engage with at least one cam mounted at the side of the plate cylinder, across the gap containing the clamps. When the roller encounters this cam, the cleaning device automatically backs away from the cylinder it is cleaning, thus avoiding interfering with the clamps, and once the cam has been passed, the said cleaning device moves back into contact with the cylinder under the elastic force exerted by the pneumatic actuators by which the movement of the device is controlled.

The above device presupposes the existence between the cylinders to be cleaned, and parallel with these cylinders, of a shaft which the device uses as a fulcrum means. For cases where no such shaft exists, the same applicants devised an apparatus disclosed in European patent application No. 01 11 2119.1 filed May 17, 2001 which exploits the cleaning device itself as a torsion bar and provides a rack-and-pinion mechanism. This apparatus preserves the advantage of the automatic backing away from the clamps of the plate cylinder, as in the previous apparatus, but takes up an excessive amount of space transversely because the means by which the cleaning device is guided and moved are all located at the opposing ends of the device and greatly increase the length or width of the entire apparatus. This apparatus is therefore suitable for printing machines in which the ends of the cylinders are sufficiently distant from the side walls of the machine frame in which they are supported or in all those cases where the printing plate occupies only part of the length or breadth of the cylinder carrying it.

The invention relates to an apparatus that performs the same functions as the apparatuses disclosed in the Italian patent application indicated above, but unlike these can be mounted on printing machines that have no shaft mounted parallel to and located between the cylinders that are to be cleaned and in which the ends of the cylinders are at perhaps only a short distance from the supporting side walls, or even where the printing plates occupy almost the whole length or breadth of their cylinder, the said apparatus having only very small fittings added to the ends of the cleaning device. According to the invention, the cleaning device is mounted via its ends on shoulders that pivot on a pair of parallel arms, these arms being hinged at their other end to the machine side walls and connected to each other by a robust torsion bar. The said shoulders are provided, at an exact distance from the point where they hinge on the said arms, with rollers that follow the profile of linear cams mounted on the said machine side walls, while at a point at approximately one hundred and eighty degrees away from the said rollers, at least one of the shoulders pivots on the rod of a linear assembly of pneumatic actuators, which assembly pivots at the other end on a point of the arm close to the point where the latter pivots on its respective machine side wall. By means of the assembly of pneumatic actuators and of the said linear cams, the cleaning device can be oriented at will against either of these cylinders to be cleaned or can be set in a position remote from both the cylinders, this position being useful as a rest position and a position for maintenance of the apparatus. Mounted on at least one of the said arms, in an intermediate position, is an idle roller designed to engage with a corresponding cam situated at the end of the plate cylinder, across the gap containing the clamps, so that the cleaning device is automatically moved away whenever it passes over the said clamps, thus preventing any interference with these.

Other features of the invention, and the advantages procured thereby, will become clearer in the course of the following description of one preferred embodiment, illustrated purely by way of non-restrictive example, in the figures of the attached sheets of drawings, in which:

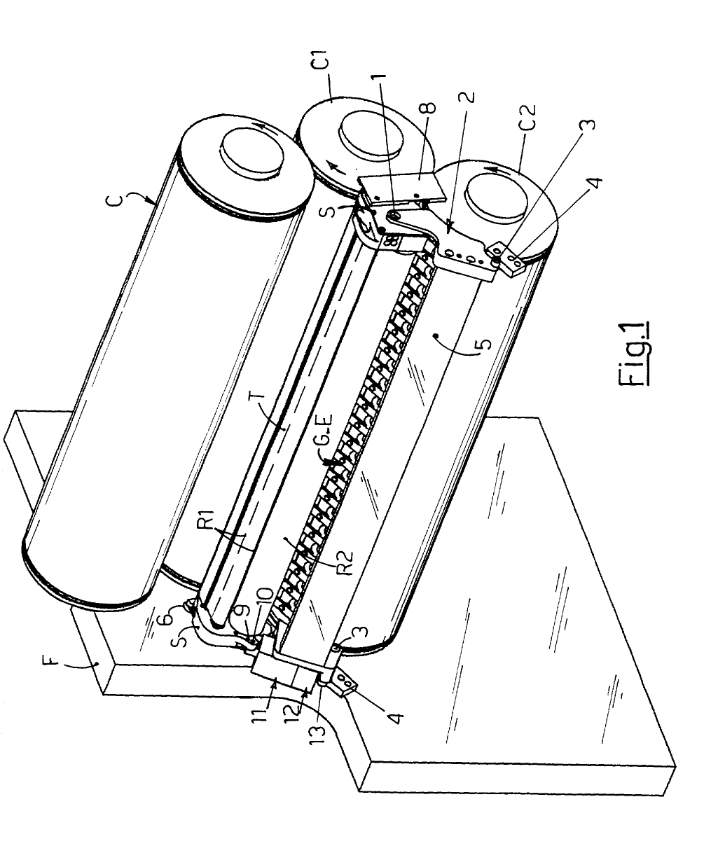

FIG. 1 is a perspective view of the apparatus in the condition of cleaning the blanket cylinder;

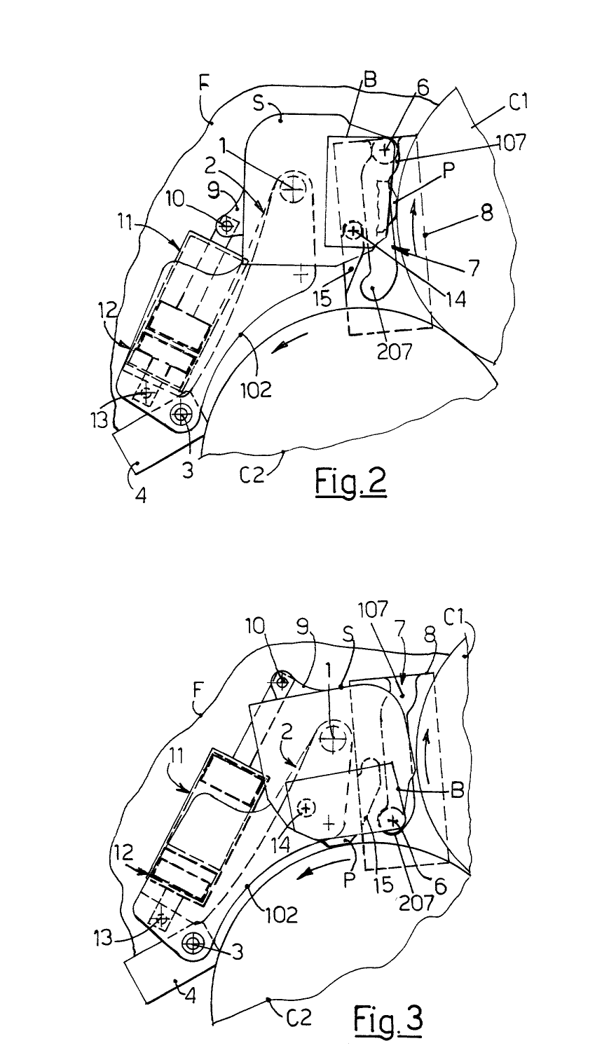

FIGS. 2, 3 and 4 are side views of the apparatus in the position of cleaning the blanket cylinder, the position of cleaning the plate cylinder and the rest position, respectively;

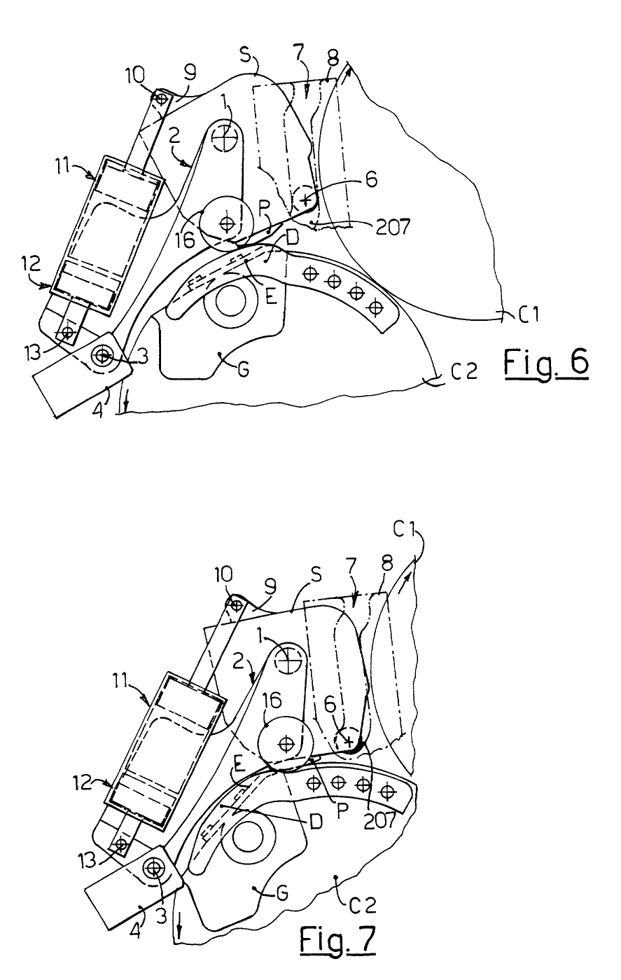

FIGS. 5, 6 and 7 illustrate the apparatus from the side and during successive stages of engagement with the cams which prevent interference between the cleaning cloth and the clamps that hold the plate on the plate cylinder.

FIGS. 1-4 show that the cleaning apparatus comprises for example a bar B that supports, in such a way that it can move parallel to the bar by its own means, the presser P. The bar B also supports the assembly comprising the nozzles that dispense washing fluid onto the cloth T, which is unwound by suitable means from a roller R1, around the assembly B, P and onto a roller R2, these means being supported by parallel shoulders S. It should be understood that the cleaning device may be of any known type and even different from that indicated above, for example of the type that comprises a brush placed in contact with the cylinder to be cleaned, onto which the cleansing fluid is dispensed uniformly. The only condition which the cleaning device must have to be able to be used with the improvements described herein, is that it must form with the shoulders S a sufficiently rigid structure with a good degree of resistance to torsional stresses.

In FIGS. 1-4, C1 indicates the upper or blanket cylinder, which in this example is in contact, at a position corresponding to approximately one or two o'clock, with the lower or plate cylinder C2. The latter has one or more gaps G containing clamps E and fitted at either side with cams D that bridge these gaps G (FIGS. 5-7). The cleaning apparatus is positioned near the region of mutual contact between the cylinders C1 and C2 to be cleaned, alongside the upper cylinder C1 and above the lower cylinder C2, parallel to both cylinders, and comprises identical spindles 1 aligned axially with each other and fixed perpendicularly to the outer flank of the shoulders S, roughly in the centre of these and parallel to the components B, P, R1, R2. These spindle S1 enable it to pivot on the ends of arms 2 whose other ends pivot at 3 on plates 4 fixed to the side walls F of the printing machine. The arms 2 are interconnected by a robust cross member or torsion bar 5, which synchronizes them in their pivoting movement about the fulcrums 3, and are characterized beneath by a curved profile 102 enabling them to operate close up to the ends of the lower cylinder C2.

The shoulders S also have on the outer flank, parallel to the spindles 1 and above the presser P when the latter is oriented towards the cylinder C1 as in FIG. 2, corresponding rollers or bearings 6 which engage in respective cam tracks 7 formed in plates 8 fixed to the side walls F of the printing machine. The cams 7 are characterized by having for example a generally Z-shaped design, with an intermediate straight and roughly vertical section, an upper section 107 inclined at for example about 45° towards the cylinder C1 and open at the top, and a lower section 207 inclined at approximately 45° in the opposite direction to the upper section 107. These parameters are of course dependent on the relative positions of the cylinders illustrated in the drawings and are therefore subject to change depending on how the cylinders are positioned.

Opposite the roller 6 of one of the shoulders S is a lug 9 providing a pivot at 10 for the rod of a double-acting pneumatic actuator 11, the base of the body of which is fixed to the base of a second double-acting pneumatic actuator 12. The stroke of the second actuator 12 is shorter than that of the first actuator and its own rod pivots at 13 on the flank of the neighbouring arm 2, a short distance from its fulcrum 3.

When the rods of both actuators 11 and 12 are retracted, as in FIG. 2, the rollers 6 of the shoulders S are positioned at the end of the upper inclined section 107 of the cams 7 and the presser P is oriented in the correct position for cleaning the cylinder C1 which is rotating clockwise, for example. The pressure of the presser P against the cylinder C1 tends, because of the reaction of the apparatus on the rollers 6, to push the fulcrums 1 away from C1. This displacement is opposed by the actuators 11, 12 or can be usefully opposed by spindles 14 parallel to the rollers 6 and, like them, fixed to the outer flank of one or both of the shoulders S, which fit into rising paths 15 formed in the inner flanks of the plates 8, which essentially repeat the profile of the upper terminal section 107 of the cams 7 and which are open towards the arms 2. When the apparatus is in the configuration of FIG. 2, the spindles 14 press against the blind upper end of the paths 15 and prevent any movement of the fulcrums 1 away from C1.

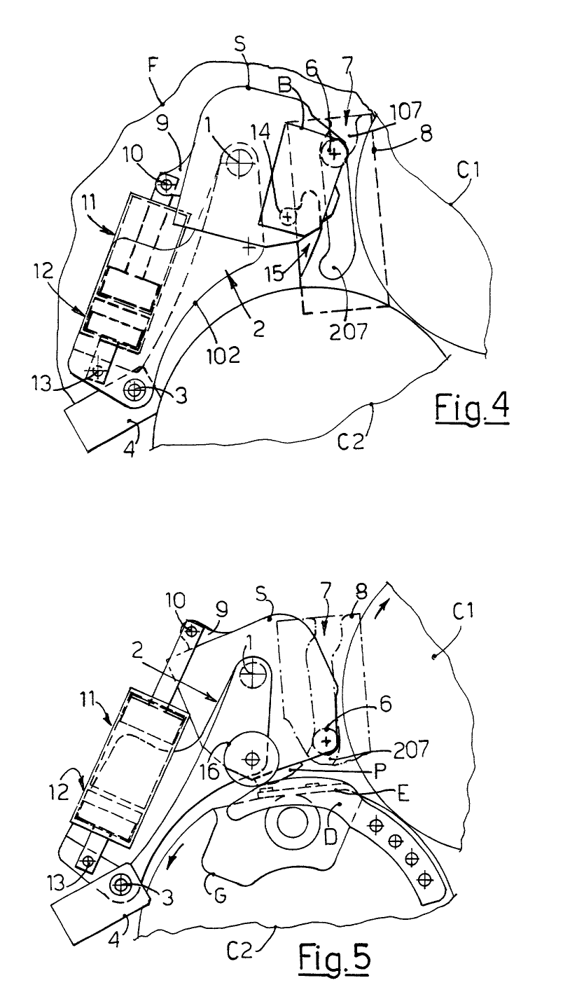

When the short-stroke actuator 12 extends its rod, the apparatus adopts the condition shown in FIG. 4, with the rollers 6 moving down to the top of the straight section of the cams 7, the spindles 14 coming out of the paths 15, and the working face of the presser P moving away from the cylinder C1 into the next region between the cylinders C1, C2. In this condition the apparatus is at rest and permits easy replacement of the cleaning cloth and maintenance of the various parts of this apparatus.

When the rod of the actuator 12 is extended and that of the actuator 11 is also extended, the rollers 6 travel down the cams 7 to the blind end of the inclined lower terminal section 207 of these cams as illustrated in FIG. 3. In this position the pressure of the presser P on the cylinder C2 tends to push the fulcrums 1 away from C2, except that this displacement is opposed by the fact that the profile of the said inclined blind lower section 207 of the cams 7 is effectively perpendicular to such displacement, so that the apparatus remains firmly in the working position on C2.

In order that, when the apparatus is working on the cylinder C2, the cloth pushed by the presser P does not interfere with the clamps E of the said cylinder, a roller 16 is mounted rotatably at an intermediate point on at least one of the arms 2: when acted upon by the cam or cams D attached to at least one corresponding flank of C2, across the gap or gaps containing the said clamps, it causes the assembly 2, 5 to pivot away from C2, as illustrated in the succession shown in FIGS. 5, 6 and 7, where it can be seen that this movement pushes the shoulders S anticlockwise and at the same time away from C2, while the rollers 6 climb back up the inclined lower section of the cams 7, so that there is automatically no interference between the presser carrying the cloth and the clamps E illustrated in broken lines. The said automatic retraction of the presser P from C2 occurs with a simultaneous and proportional retraction of the rods of the actuators 11, 12 which are constantly under pressure to extend by the pressed air, in such a way that after passing over the cam D, the apparatus automatically returns the presser and the cloth into contact with the cylinder C2. It should be understood that, in contrast to the illustrations and as is clear from FIG. 5, rollers 16 may be placed on both the shoulders S of the cleaning device rather than on at least one of the pivoting arms 2, thus resulting in the desired automatic separation of the cleaning device from the cylinder C2 whenever the clamps E pass under it. It will be understood that the description has been given with reference to a preferred embodiment of the invention, to which numerous variation modifications can be made, especially from the point of view of construction, relating for example to setting up the apparatus in such a way that it can at will clean the cylinder C2, or cylinder C1 or a higher cylinder C as illustrated in FIG. 1. Other variants may relate to the shape of the cams 7 or the orientation of the entire apparatus and its components, which may vary depending on the disposition of the cylinders to be cleaned with respect to the horizontal and vertical planes and depending on the relative dispositions of the cylinders themselves.

1. Apparatus for alternatively cleaning two or more cylinders (C1, C2) of a printing machine, by means of a single cleaning device set parallel to and between the said cylinders, characterized in that this cleaning device is attached to its shoulders (S) in such a way as to form an overall structure with resistance to torsional stresses, identical spindles (1) being attached to the outer flanks of the said shoulders and aligned axially with each other, parallel to the longitudinal axis of the cleaning device and at a suitable distance from the member (P) for contacting the cylinder that is to be cleaned, by means of which spindles the said shoulders pivot on the ends of respective parallel arms (2) that are connected to each other in an intermediate part by a cross member or torsion bar (5) and that pivot at the other end on plates (4) fixed to the side walls (F) that support the said cylinders of the printing machine; on which latter end of at least one of the said arms there pivots an assembly of pneumatic actuators (11, 12), which assembly pivots at the other end on a lug (9) integral with a corresponding shoulder (S) of the cleaning device which carries, on the opposite side from the said lug, integrally on the outer flanks of the said shoulders (S), rollers (6) that read the slotted profile of cams (7) formed in plates (8) attached to the side walls (F) of the printing machine; arrangements being made such that as a result of the extension or retraction of the said assembly of pneumatic actuators (11, 12), the shoulders (S) rotate in one direction or the other and position themselves so that the said rollers (6) are at either of the suitably profiled and oriented ends (107, 207) of the said cams (7), in order to orient and correctly position the contact member (P) of the cleaning device against one or other of the cylinders to be cleaned.

2. Apparatus according to claim 1, in which at least one of the pivoting arms (2) on which the cleaning device is supported is provided in an intermediate position with at least one idle roller (16) intended to be acted upon by the cam or cams (D) attached to at least one flank of the lower cylinder (C2), across the gap or gaps (G) of this cylinder, in order automatically to lift the said cleaning device and prevent interference between its active member (P) and the clamps (E) located in the gaps of the said cylinder (C2).

3. Apparatus according to claim 1, in which the shoulders (S) of the cleaning device are provided laterally, alongside the active member (P) of the said device, with respective idle rollers (16) designed to be acted upon by respective cams (D) attached to the flanks of the lower cylinder (C2), alongside the gap or gaps (G) of this cylinder, in order automatically to lift the said cleaning device whenever the said cams pass under the said rollers, to prevent interference between the said active member (P) carrying the cloth, and the clamps (E) located in the said gap or gaps (G).

4. Apparatus according to claim 1, in which the cylinders to be cleaned are positioned one above the other, with the upper or blanket cylinder (C1) touching for example the lower or plate cylinder (C2) at approximately between one or two o'clock, characterised in that the slotted cams (7) are located at the side of and a short distance from the upper cylinder (C1) and their form is that of a broken line, with a straight, almost vertical intermediate section, an optional upper section (107) inclined for example at an angle of between 200 and 700, preferably approximately 450 with respect to the intermediate section, oriented towards the said upper cylinder (C1) and preferably open at the top, and a lower section (207) that is also inclined at approximately 450 with respect to the said intermediate section, oriented in the opposite direction to the said upper section (107) and preferably blind.

5. Apparatus according to claim 4, in which the terminal end sections (107, 207) of the fixed cams (7), or at least the lower terminal section (207) of these cams, is oriented so as to oppose the displacement to which the cleaning device would be subject as a result of the action of the associated active member (P) and of the force which this exerts on the cylinder that is to be cleaned.

6. Apparatus according to claim 4, in which the blind lower terminal section (207) of each fixed cam (7) is oriented in such a way as to allow the free lifting therein of the end spindles (1) of the shoulders of the cleaning device whenever the roller or rollers (16) mounted on the pivoting arms (2) or shoulders (S) of the said device are acted upon by the lateral cam or cams (D) of the lower cylinder (C2) across the gaps (G), to prevent interference between the active member (P) of the cleaning device and the clamps (E) of the cylinder (C2).

7. Apparatus according to claim 1, characterized in that in order to enhance the stability of the said apparatus when it is in the position of cleaning the upper cylinder (C1), the outer flanks of at least one or of both of the shoulders (S) of the cleaning device are provided with spindles (14) which fit into blind rising paths (15) formed in the same plate (8) as the cams (7) and which, when in the upper end of the paths, prevent any movement of the cleaning device away from the upper cylinder when the latter is being pressed against by the cleaning member (P) of the said device.

8. Apparatus according to claim 7, in which the said blind rising paths (15) have a profile and an orientation that essentially repeats that of the upper terminal section (107) of the main cams (7).

9. Apparatus according to claim 1, in which the pivoting arms (2) are characterized by a curved lower profile (102) enabling them to operate in close proximity to the ends of the cylinder (C2) over which they are positioned.

10. Apparatus according to claim 1, in which the assembly of pneumatic actuators that work the said apparatus comprises two actuators (11, 12) having different strokes, these actuators being axially aligned with each other and fixed to each other via the bases of their bodies, to provide the said apparatus with at least the following three working conditions: when the rods of both actuators are extended, the apparatus is in the position of cleaning the lower cylinder (C2); when the rods of both actuators are retracted, the apparatus is in the position of cleaning the upper cylinder (C1); and when the rod of the long-stroke actuator (11) is extended and that of the short-stroke actuator (12) retracted, the apparatus has its cleaning member (P) away from both cylinders (C1, C2), in a position of rest useful for maintenance operations.
